(19) United States
(12) Patent Application Publication
(10) Pub. No.: US 2014/0245158 A1
(43) Pub. Date: Aug. 28, 2014

(54) Virtual Interoperability and Information Sharing Engine

(71) Applicant: G&H INTERNATIONAL, INC., Washington, DC (US)

(72) Inventors: Robert Greenberg, Washington, DC (US); Jonathan David Fisk, Washington, DC (US); Sara L. Moore, Washington, DC (US); Jeffrey J. Sopel, Washington, DC (US)

(21) Appl. No.: 13/774,929

(22) Filed: Feb. 22, 2013

(51) Int. Cl. G06F 17/30

(52) U.S. Cl. CPC G06F 17/30386
USPC 715/733

(57) ABSTRACT

The present invention includes an emergency management system and method to manage collections of information that provide situation awareness and decision support for specific real world situations, such as hurricanes, sporting events, conventions, power outages, etc. The present invention provides a role-based content assembly process that powers a flexible viewing capability, based on “awareness packages” that have been approved for production use by the commander.

### CROSS-REFERENCE TO RELATED APPLICATIONS

Not applicable

### BACKGROUND OF THE INVENTION

1. Field of the Invention

The present invention relates to systems for emergency management that include display of geographic data.

2. Description of Related Art

Emergency management is a decisions business. As a decisions business, almost nothing is more valuable than the right information at the right time. Although they are often invisible to the eye, jurisdictional boundaries can become very real barriers to the right information when needed; information that could help in responding to an emergency situation.

One particular technology area that is heavily used in emergency management is geographic data overlaid onto local maps. For example, during a power outage, a map that displays local emergency shelters could be critical. Similarly, maps that display weather data, locations of personnel or other resources, road closures, operational status of critical assets, evacuation routes, and planned events and staging areas, may be useful in different situations. This displayed information typically comes from data feeds served by third-party computers, which are frequently controlled by public agencies. For example, a data feed for weather might be provided by the National Oceanic and Atmospheric Administration (NOAA).

Currently, a collection of particular data feeds can be created and stored with a map. When the map is viewed in a standard viewer (such as Oregon's RAPTOR or Florida GATOR), the data from the data feeds can be seen on the map.

Such a map is preconfigured to show the same view for every user every time it is opened. While there are many catalogs of government map services and data feeds, most of them were created to be general-purpose metadata repositories of minimal value to operations minded agencies.

This technology has a number of disadvantages, however. First, the collection of data feeds with a particular map lacks any sense of the purpose of the collection and lacks the ability to reuse that collection of data feeds with a different map. Traditional data clearinghouse projects go to great lengths to categorize and describe the data they store and/or index as web services or maps. They include information such as limitations to the data, frequency of updates, as well as information about the agency and the procedures used to maintain that data. With accessibility and metadata as the primary goal, the clearinghouse/data portal will necessarily focus on describing a data publisher's singular use of content.

Such systems do not focus on reuse of this content. Moreover, these systems do not enforce any sort of workflow for creating content, meaning that lead decision makers (sometimes called the operations chief or incident commander), who must prepare their agency to make effective decisions in real-time and under changing conditions, are not necessarily the ones driving the content.

While there are web-based Geographic Information System (GIS) platforms that allow individuals to create maps from web accessible data feeds, map services, and other GIS content, these systems do not capture either the operation chief's purpose nor his or her specialized information needs. Using existing industry tools and workflows, a “webmap” can be created on an informal or project basis by a GIS analyst, but analysts often do so without understanding the real-time context in which the information will be used, or appreciating the decisions which their “webmap” may have to support. Without beginning as a commander-initiated purpose, or having a mechanism to review and approve content for agency-wide distribution, it is extremely difficult, if not impossible for decision makers to proactively manage their agencies information requirements that span numerous missions, emergency situations, and jurisdictions.

Additionally, viewing platforms are not currently designed to conform themselves to the information needs of the lead decision maker. Rather, they are designed at a moment in time by a web developer or configured by a GIS Analyst to serve particular content to a particular user or group of users or event.

Finally, during an emergency, response agencies often need to have common situational awareness that allows for collaboration with other complementary agencies/disciplines such as fire, police, public health, utilities and other partner organizations. Current GIS viewer technology does not allow partner agencies to share either particular data sets or collections of data sets in a seamless manner. When available, this information is pre-wired to various agency-viewing platforms, which makes it impractical to combine it into a single view when each agency has its own information requirements. It is also not possible to share built-in viewer content, because these platforms are not designed to facilitate sharing. This technology can also be confusing to users from multiple agencies, which have to manually rewire their viewer platforms while they are actively supporting emergency operations.

### BRIEF SUMMARY OF THE INVENTION

The present invention provides a system and method to manage collections of information that provide situation awareness and decision support for specific real world situations, such as hurricanes, sporting events, conventions, power outages, etc. This collection of information is referred to as an “awareness package.”

The present invention provides a role-based content assembly process that powers a flexible viewing capability, based on awareness packages that have been approved for production use by the commander. This distinction means that all members and/or guests of that organization have access to a continuously evolving reflection of the commander's mission driven information requirements, rather than an isolated product prepared by a vendor or a member of the agency's staff.

Using a role-based workflow and a suite of web applications, the “Commander” names a specific event, condition, or situation that falls within his or her own agency's area of responsibility, and proceeds to describe a collection of web accessible feeds and content necessary to support the critical decisions he or she will have to make during that event.

Operating from this unifying purpose, information specialists within the organization are assigned to collect necessary information and/or broker new data partnerships that often re-use and/or create new content to fulfill a specific mission. When content that provides situational awareness and other context is assembled for a specific purpose, provided back to the Commander, the organization at large, and other partnering agencies, that collection of content is called an Awareness Package. This collection can contain geospatial feeds from major platforms such as ArcGIS REST, as well as common formats such as KML, WMS and non-spatial links to web applications, social media, websites, or any other web accessible source.

When an agency uses the present invention, once it has approved and shared an awareness package with another partner agency, commanders from either agency have the capability to use that package as a template from which to derive a new unique information set, without having to re-assemble that content. Using the same Commander-Analyst workflow, this new awareness package can be used internally by the recipient agency, or shared back with the originating agency.

An awareness package includes a collection of data feeds and spatial context, as well as a description of the purpose (or “mission”) of the package. The spatial context preferably includes map data that can be viewed in a viewer. The data feeds may be data layers that can be overlaid onto the spatial context, static documents (such as operator's guides or situational checklists), updated tabular data, or any other data appropriate for the mission.

Preferably, data feeds can be selected from a catalog. The catalog would consist of common, ready to use web formats such as map services, feeds, web or mobile applications, social media collections, and other web media.

An awareness package begins with a request from a user in the “commander” role (e.g., an operations section chief or other person with similar authority) for a collection of data feeds and spatial context that will provide situation awareness for a specific event or mission. The status of the awareness package at this stage is “in development”.

The request is then assigned to an analyst to assemble. The present invention provides an awareness package toolkit module that is used to assemble content from public data catalogs. In some embodiments, the commander may be able to assemble the awareness package. It is preferable, however, to have an “analyst” role for assembling the awareness package itself that is separate from the commander role. The advantage is that the user with the commander role should have expertise in emergency management, but does not need expertise in the technical aspects of assembling data feeds. The user with the analyst role is expected to understand those technical aspects. In small agencies, one person may fill both roles.

The completed awareness package will contain an organized collection of data layers that can be shared and displayed as a single unit. Once an awareness package is completely populated, the analyst changes its status to “review.”

An awareness package may stay under review until the commander is satisfied with its content and changes its status to “production.” During this time the analyst may make changes to the awareness package. Operations personnel may monitor the progress of the request and examine content within the collection during this stage.

When the commander is satisfied with the package they may change its status to “production,” which will lock the awareness package. The commander may change the status back to “in development” in order to unlock the package and allow modifications.

The analyst role may create a new awareness package for the operations section to “review,” without an originating request if desired. However, only the commander role may change its status to “production.”

The present invention also includes an awareness package widget. Any user may use the awareness package widget to visualize awareness packages. Users are presented with a list of available awareness packages. Standard users can only see awareness packages in the “production” state. The commander also has the ability to designate a certain awareness package as being the current default for the agency. The default package will appear on a front panel of the user interface that is presented to users when first logging in.

For example, if the catalog has an awareness package for “Local High School Graduation,” on the day of the graduation the commander would designate the Local High School Graduation package to be the default. Any operator logging into the system would be directed to use the default package, and would see all of the information that the commander designated to be in that package.

The widget may be installed as a plugin to an existing GIS viewer or may be a standalone viewer. Preferably, the widget requires a username and password that authenticates the user.

The present invention allows for the creation and management of a catalog and/or database of awareness packages. This catalog is preferably searchable using known search techniques, such as keyword searching.

The present invention also provides the ability to share awareness packages. An Administrator or Commander can share an awareness package with another agency that also uses the present invention. This encourages agencies to coordinate with each other by viewing the same data at the same time. Another use of sharing is to allow one local agency to share with an agency in a different geographic region.

Sharing awareness packages enables agencies to better coordinate and collaborate with one another by having a common operating understanding of what is occurring in each other's jurisdiction. For example, during an emergency it is important for agencies in adjacent jurisdictions to know when shelters are being opened, what roads are open or closed (for evacuation or supply purposes) and so on.

Similarly, sharing information across agency and jurisdiction enables more informed decision-making. For example, resource management is a critical task during an emergency. It is critical for an emergency manager to understand where all of the resources of their emergency support functions (there are fifteen ESF's) are deployed at any given time so he or she can decide where to fill in the gaps.

In addition to government-to-government sharing it is also important for government agencies to share with the private sector during an emergency. Often the actual “first” responder may come from one of the critical infrastructures such as the utilities or the telecommunications companies. They need information available to government, such as road closures or blockages, so that they can more effectively and efficiently deploy their resources to help bring power or communications back on.

The reverse is also true. It is important for emergency officials to know where the private sector is focusing its efforts at any given time as well as what resources they might have on hand to help out. For example, knowing what resources the “big box” stores such as Walmart and Target have on hand is important for emergency officials who are constantly assessing how to provide supplies to the public and their own staff.

### BRIEF DESCRIPTION OF THE SEVERAL VIEWS OF THE DRAWINGS

FIG. 1 illustrates a hardware embodiment of the present invention.

FIG. 1A shows a screenshot of an exemplary user interface of a viewer.

FIG. 2 illustrates possible states of an awareness package and transitions between those states.

FIG. 3 lists and describes possible user roles.

FIG. 3A shows a screenshot of an exemplary user interface for sharing awareness packages.

FIG. 4 illustrates a method of creating an awareness package.

FIG. 4A shows a screenshot of an exemplary user interface for creating an awareness package.

FIG. 5 illustrates a method of assembling an awareness package.

FIG. 5A-5C show screenshots of an exemplary user interface for assembling an awareness package.

FIG. 6 illustrates a method of reviewing an awareness package.

### DETAILED DESCRIPTION OF THE INVENTION

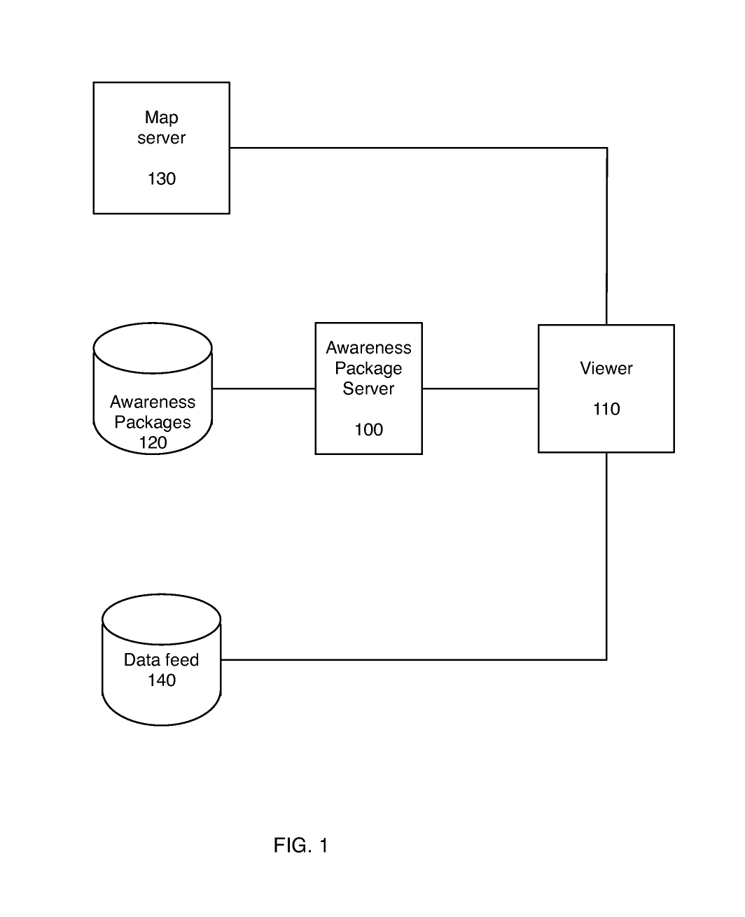

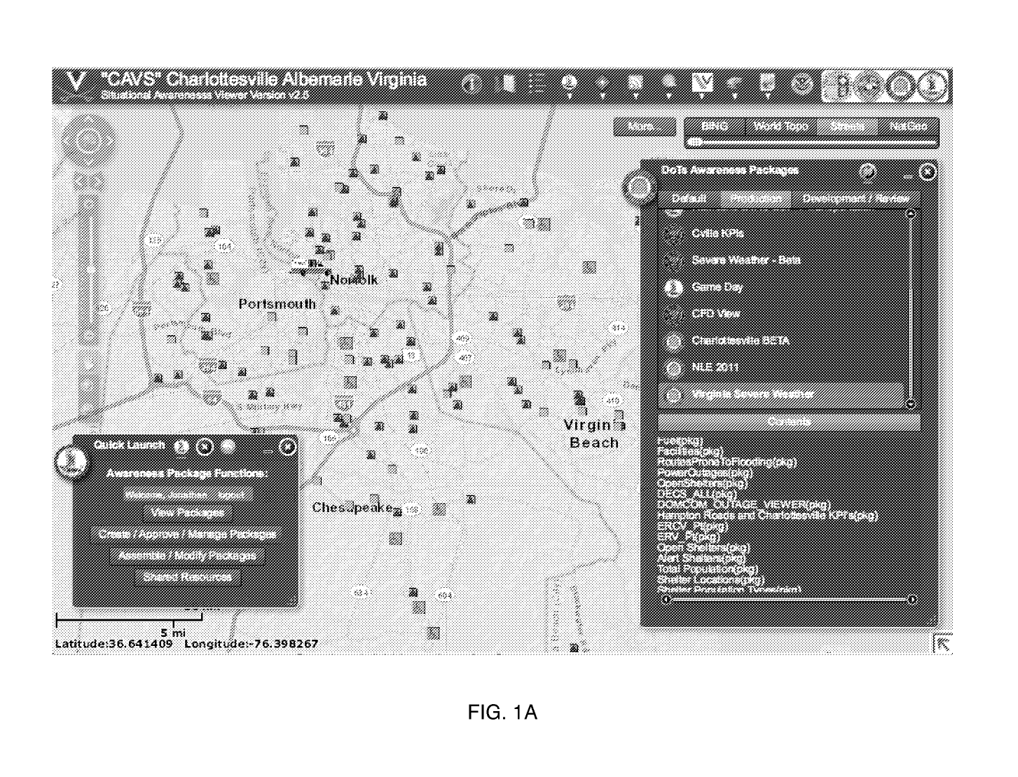

FIG. 1 illustrates a possible embodiment of the present invention. It includes an Awareness Package Server 100 and an Awareness Package Database 120. The system also provides a viewer 110, either as a standalone client, or as a plugin to an existing client. The system interacts with at least one map database 130 and at least one data feed server 140.

The Awareness Package Server 100 and Database 120 store and manage awareness packages. Semantically, an awareness package includes a collection of data feeds and spatial context, as well as a description of the purpose (or “mission”) of the package. The spatial context preferably includes map data that can be viewed in a viewer. The data feeds may be data layers that can be overlaid onto the spatial context, static documents (such as operator's guides or situational checklists), updated tabular data, or any other data appropriate for the mission.

In terms of actual data, an awareness package includes data fields describing the purpose and content of the package. Preferably, the awareness package data includes keywords to enhance the ability to search for the package.

As part of the content of the package, the package includes a set of data feeds. Each data feed has a description and a URL pointing to the location of the data feed. This data feed can be any data feed that is displayable by an appropriate viewer. For example, the ArcGIS® system can display a variety of data feeds on a GIS system, such as an ArcGIS® Rest Service, WMS, KML, Open Street Map, or tiled map services. Non-spatial feeds can include links to specific social media accounts such as a state emergency management office or local fire department. Websites, PDF files, or any other web resource with a URL can also be included as data feeds.

The Awareness Package Server 100 preferably includes a catalog of data feed servers (not shown). This catalog contains lists of a variety of data feeds that can be included as part of an awareness package.

The viewer 110 may be a standalone viewer, or it may be a plugin that works within a preexisting viewer, such as the ArcGIS viewer. The viewer 110 provides a user interface for accessing, viewing, searching, creating, assembling, managing, and otherwise working with awareness packages, as well as administering the system. FIG. 1A shows a screenshot of an exemplary embodiment of a viewer.

The map database 130 is provided as an input to the present invention. Preferably, map database 130 is a Geographical Information System (GIS) database. Important dynamic database content can be spatially enabled and published from emergency management systems such as WebEOC, or from 911 CAD Centers, or other widely used database servers such as Microsoft SQL Server, Oracle, or PostGRES.

The viewer 110 accesses the map database 130 to provide the geographical context for data feeds in an awareness package. FIG. 1B shows an example of an awareness package being displayed in such a geographical context.

A data feed server 140 is a third-party server that provides a data feed that can be displayed as part of an awareness package. As noted above, a data feed could be provided by a server offering an ArcGIS® Rest Service, WMS, KML, Open Street Map, or tiled map services. A data feed server 140 could also be a social media server, networked file server (e.g., FTP), or a web server.

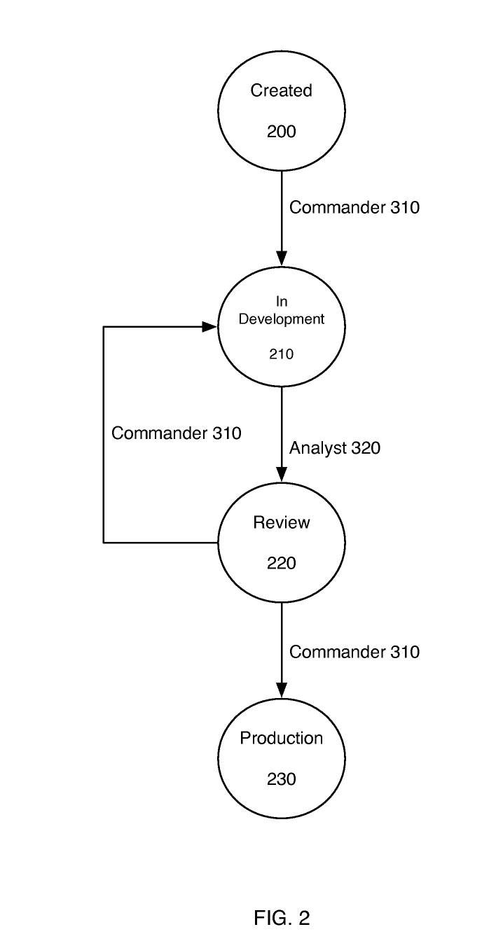

FIG. 2 shows a preferred set of states in which an awareness package can be, as well as the possible transitions between them. The initial state of an awareness package is Created State 200. Only a Commander 310 or Administrator 300 (see below) can see and edit an awareness package in Created State 200. As described below, a Commander 310 or Administrator 300 can change the state of an awareness package from Created State 200 to In Development State 210.

An awareness package in the In Development State 210 is viewable and editable by the Analyst 320 to whom it is assigned (or any user role with greater permission). Other users with the Analyst 320 role will not see the awareness package, nor will Standard Users 330 or Guest Users 340. The Analyst 320 who “owns” the awareness package can change its state to Review State 220.

All users with the Analyst 320 role or higher permissions can see any awareness package in the Review State 220. Only a Commander 310 or Administrator 300 can make changes to an awareness package in the Review State 220. The Commander 310 or Administrator 300 can change the state to Production State 230 if the awareness package is approved for use (see below) or back to In Development State 210 if it needs additional changes by the Analyst 320 (see below).

All users can see an awareness package that is in Production State 230. No user can directly modify an awareness package in Production State 230. A Commander 310 or Administrator 300 can modify such an awareness package using a copy of the awareness package that then overwrites the original package. (See below.)

The system of the present invention is accessed by authorized users. Preferably, a user will log in with a username and password, although any known authentication technique may be used. Each user is assigned a role within the system, and the role defines what the user is able to see and what actions the user is able to take.

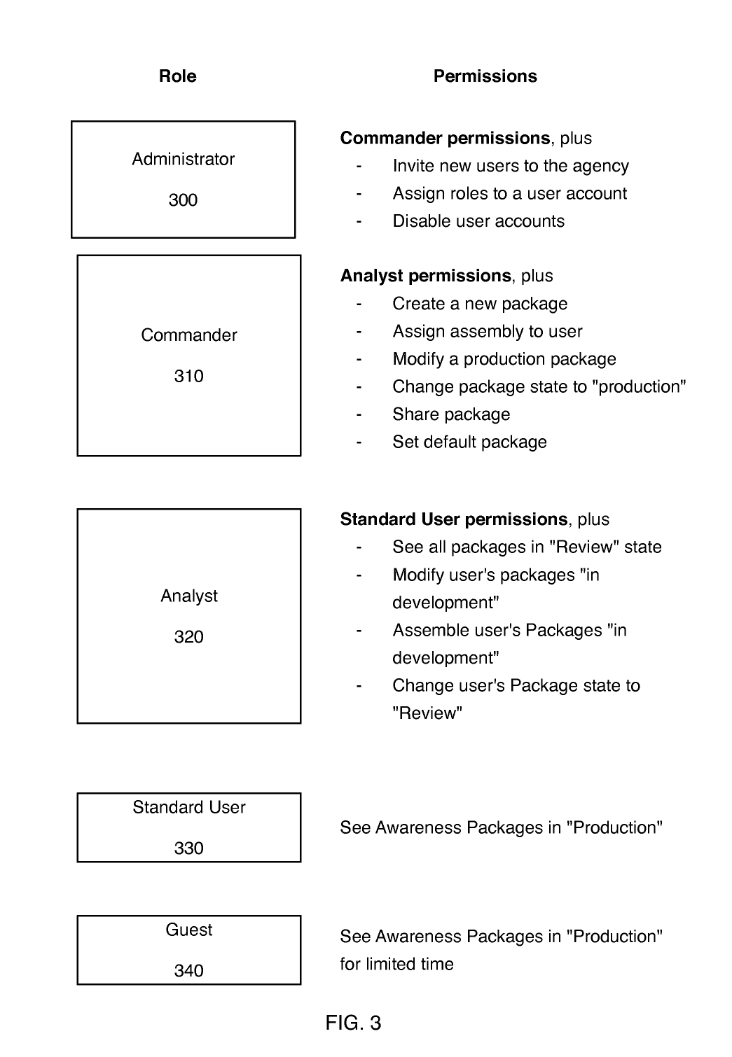

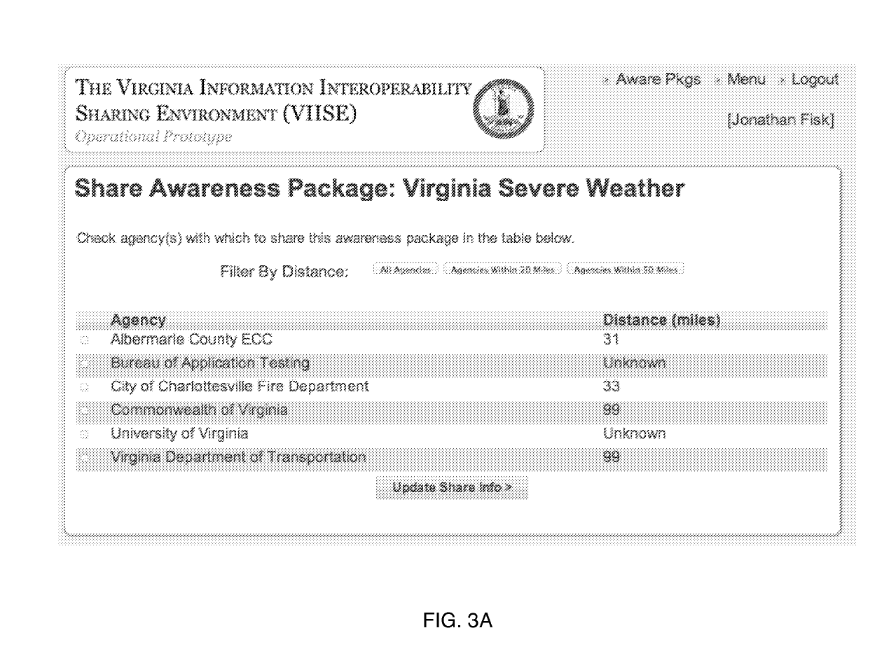

FIG. 3 shows a preferred set of user roles for use in the present invention. The user roles are hierarchical in the sense that a role includes all of the permissions of the roles below it in the hierarchy. For example, a user in the Commander role includes all of the permissions of users in the Analyst and Standard User roles. Note that it is not required that separate individuals be assigned each role. In a small agency, one person might act as Administrator 300, Commander 310, and Analyst 320; or there might be only one Analyst 320.

A Standard User 330 represents a standard user of the system, such as a dispatcher, watch officer, police, fire, medic, ESF volunteer, officials, or supporting or responding staff from local, state, Federal, or non profit agencies. Such users need access to any awareness package that is in the “production” state, i.e., that a Commander 310 has indicated is complete (as described below). Preferably, when a Standard User 330 logs in, he is presented with an interface that shows any particular Awareness Package that the Commander 310 has designated as being the default for the agency, although the Standard User 330 can browse through other Awareness Packages in the “production” State. A Standard User 330 can load one of those Awareness Packages into his viewer so that he can see the data associated with it.

The lowest level user is a Guest User 340. The purpose of the Guest User 340 role is to allow temporary access to awareness packages that are in production. For example, during an emergency or large event, it may be advantageous to provide temporary access to appropriate awareness packages for members of other agencies in order to ensure that all personnel have the same information available. In some embodiments, a guest user is set to automatically expire after a particular amount of time, so that such a user will only have access for a pre-set length of time. This would be advantageous for events that are intended to last for a known duration, like a graduation, convention, parade, or other scheduled event. Alternatively, an Administrator 300 may manually grant or revoke access to guest users. Except for the temporary nature of the role, a Guest User 340 is otherwise the same as a Standard User 330.

The primary purpose of the Analyst 320 is to perform the technical tasks associated with assembling and modifying an awareness package. As discussed below, a Commander 310 can create an awareness package and request a set of data feeds by describing what those data feeds should contain. An awareness package created for a game day, for example, may include weather radar, planned road blocks and modified traffic patterns, VIP parking area maps, 911 calls, traffic accidents, twitter feeds from official state or local emergency services, the location of mobile command centers, live tracking feed of deployed personnel, etc.

Once a Commander 310 has created the basic definition of an awareness package, he assigns it to an Analyst 320 for assembly and puts it into the “in development” state. An Analyst 320 can see all “in development” awareness packages assigned to him to assemble, as well as all awareness packages that are in the “review” or “production” states.

With respect to awareness packages that are “in development”, the Analyst 320 goes through the Commander 310's requested data and adds the appropriate Uniform Resource Locators (“URLs”) for data feeds satisfying the Commander 310's requests. Preferably, the present invention provides a searchable catalog of data feeds for the Analyst 320 to use. Once the Analyst 320 has added actual data feeds for all of the Commander 310's requests, the Analyst 320 changes the state of the awareness package from “in development” to “review”. Once the awareness package is in the “review” state, the Analyst 320 can no longer make changes to it.

The Commander 310 is a user with an understanding of what data is useful for different situations. A Commander 310 may be a chief of operations, police chief, fire chief, a task force lead, an incident commander, fire battalion or section chief, a special event coordinator, emergency service function (ESF) lead, emergency manager, city manager, mayor, governor or other lead decision maker during a event.

The Commander 310 can create an awareness package from scratch or using another awareness package as a template. As discussed below, the Commander 310 describes the purpose of the package and describes the data feeds that should be included. The Commander 310 does not typically enter the actual data feeds; that task is normally done by an Analyst 320. Once an awareness package is fully described, the Commander 310 assigns it to an Analyst 320 for assembly and changes the state to “in development”.

As described above, an Analyst 320 assembles an awareness package and places it into the “review” state. The Commander 310 can see all awareness packages. The Commander 310 reviews an awareness package in the “review” state by looking at its contents; the Commander 310 can approve it by changing the state to “production” or reject it by changing the state back to “in development”.

The Commander 310 also has permission to share awareness packages with other agencies. Once a package has been approved a commander or higher can share an awareness package with another agency that is also using the present invention. Within the management console there is an option available to share with another agency within the system. Any member agency can be selected.

FIG. 3A illustrates an exemplary user interface for sharing an awareness package. In order to have multiple agencies using the same system, it is desirable to have a super-user role (not shown) with the ability to add, remove, and manage agencies. This super-user would belong to the organization that operates the system, rather than being part of an agency.

When one or more agencies are granted access to this awareness package, all members of those agencies from Guest to Administrator have access to view that awareness package when they login and access the viewing capability from the viewer. Shared awareness packages appear next to their own agency's awareness packages, but they are denoted with a logo, official seal, or similar marking to indicate the originating agency.

In addition, the recipient agencies are able to use this package as a template for creating their own awareness packages. As described above, during this process an agency can choose to remove any of the URLs or map layers that are not relevant to its mission.

The Commander 310 can update numerous profile details, such as the agency name, its abbreviation, address, location, logo, official website, Twitter handle and Facebook URLs. This list is intended to be exemplary; other profile details are possible, as would be understood by one of ordinary skill in the art.

An important function of the Commander 310 role is to set the default awareness package for the agency. The default package is presented on the front panel of the viewer 110 when a user logs in to the system. Typically, the default awareness package has particular importance for the current situation. For example, on the day of a sporting event, the Commander 310 might make a Game Day awareness package the default. As a further example, if a hurricane is approaching, the Commander 310 might make a hurricane awareness package the default. The default awareness package helps ensure that all operators have appropriate information, without requiring them to search for the right awareness package or manually search for appropriate data feeds.

The Administrator 300 role has all of the permissions of the Commander 310 role, plus the ability to manage user accounts. This includes adding new users, assigning a role to a user, and disabling a user. In a small agency, there might be an Administrator 300 without a separate Commander 310.

When a Commander 310 (or Administrator 300) chooses to modify a “production” awareness package, the existing awareness package remains in use and intact. In this case the system creates a copy of the production package currently in use, assigns it a nearly identical temporary name, it changes the status to “in development,” and then the Commander 310 assigns an Analyst 320 or above to do the assembly workflow described below. When the Analyst 320 is through with edits, he changes the state to “review,” and if it is approved, a Commander 310 changes the state to “production.” Preferably, when this type of modified package is approved the system immediately over-writes the “production” awareness package that was previously in use with the newly modified package. As a result, all users see an updated “production” package without interrupting its use or taking it offline.

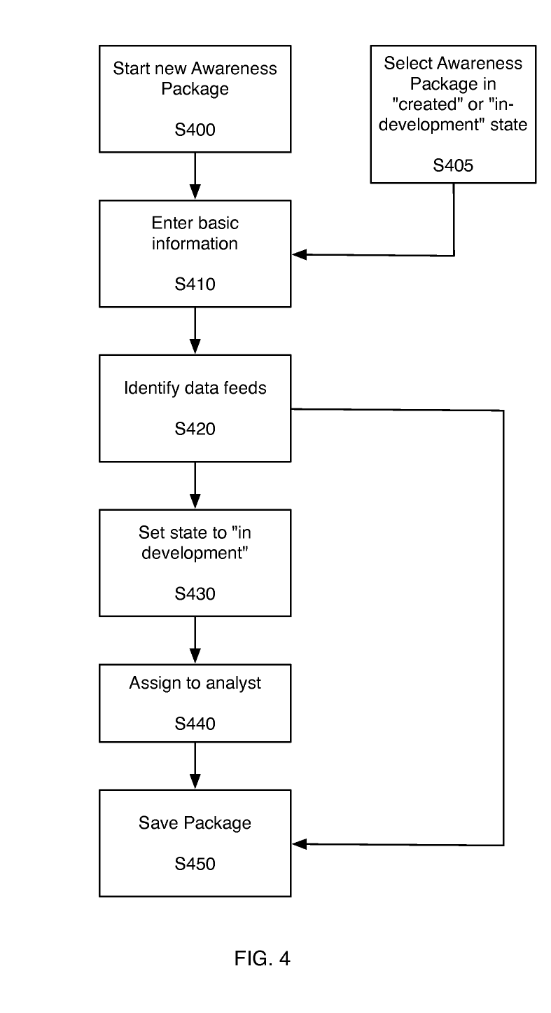

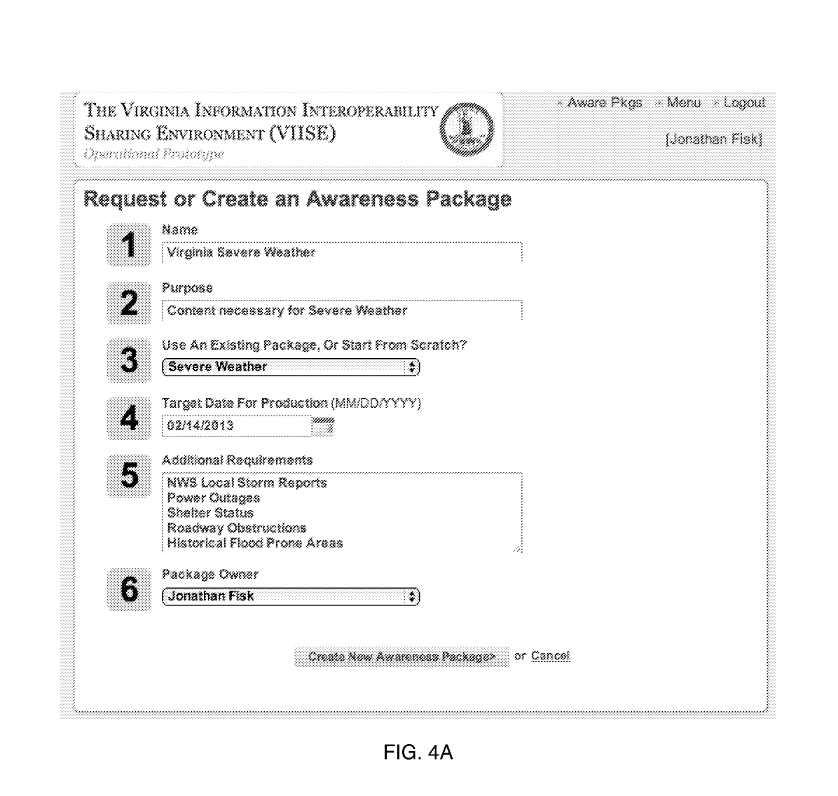

FIG. 4 illustrates an exemplary workflow for creating an awareness package. In step S400, a Commander or Administrator uses a user interface to create an awareness package record. Alternatively, the user can start with step S405 by selecting an existing awareness package that is in either the “created” state or the “in-development” state. This user then enters and/or edits basic information about the awareness package in step S410. This information includes the name of the awareness package; the operational purpose for this package; and the desired target date for completion.

In step S420, the user adds and/or updates a set of data feeds. The Commander will typically itemize data elements, or provide other instructions that will aid those assembling the content. For example, the Commander could request information regarding power outages, local storm reports, and the status of local shelters. These instructions could also include important geographic areas or resources and personnel to utilize during the data collection. Typically, the user will describe the desired data feeds, but will not know the actual URL associated with any particular data feed. If the user knows the URL for a data feed, he can enter it. Otherwise, an Analyst will locate the URL in the assembly workflow, described below. The user is also able to delete data feeds (not shown).

If the Commander or Administrator is not ready to have the awareness package assembled, the workflow can proceed from step S420 to step S450. Otherwise, the workflow moves to step S430, in which the awareness package state is changed to “in development,” which allows an Analyst to assemble it.

In step S440, the user assigns the awareness package to an Analyst for assembly. As noted above, an Analyst can only see “in development” awareness packages that have been assigned to him or her. This is desirable because it prevents the problem of having simultaneous people working on a single awareness package. Only the owner of an awareness package can assemble content or modify it. When an Analyst or higher role opens the assembly tool they are presented with a list of the packages that they own, which also have a status of “in development”. As explained above, packages under “review” or in “production” cannot be changed, unless the commander changes their status to “in development.” Should the Commander not be satisfied with the result, or the assigned Analyst is not able to perform the task the Commander can change the owner of a package at any time. In some cases with a smaller agency the Commander may decide to assign himself as the owner of the package, and assemble the package himself from the start.

In step S450, the awareness package is saved.

FIG. 4A shows an exemplary embodiment of a user interface for practicing the workflow of FIG. 4.

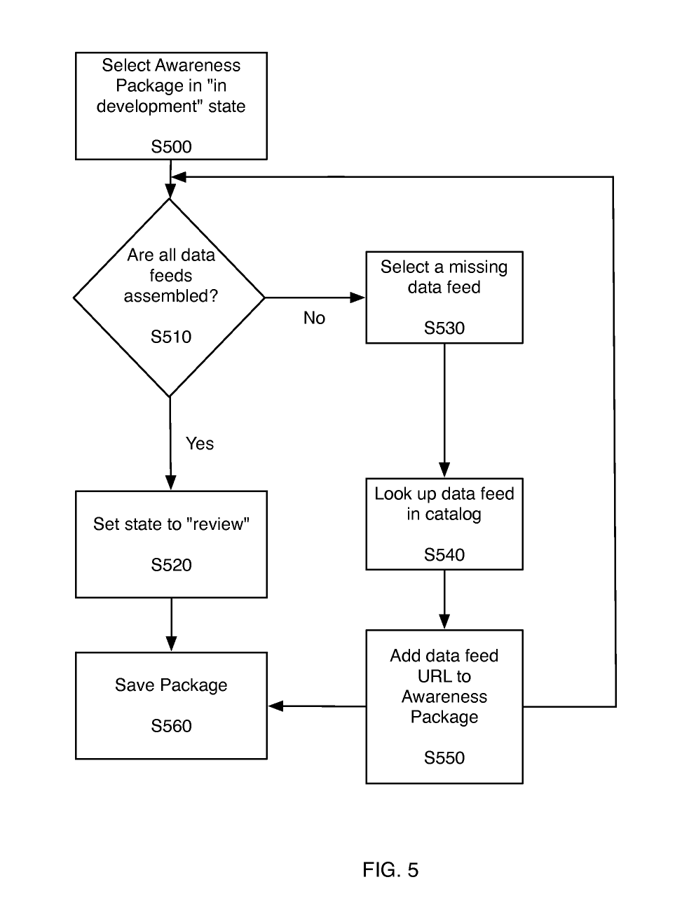

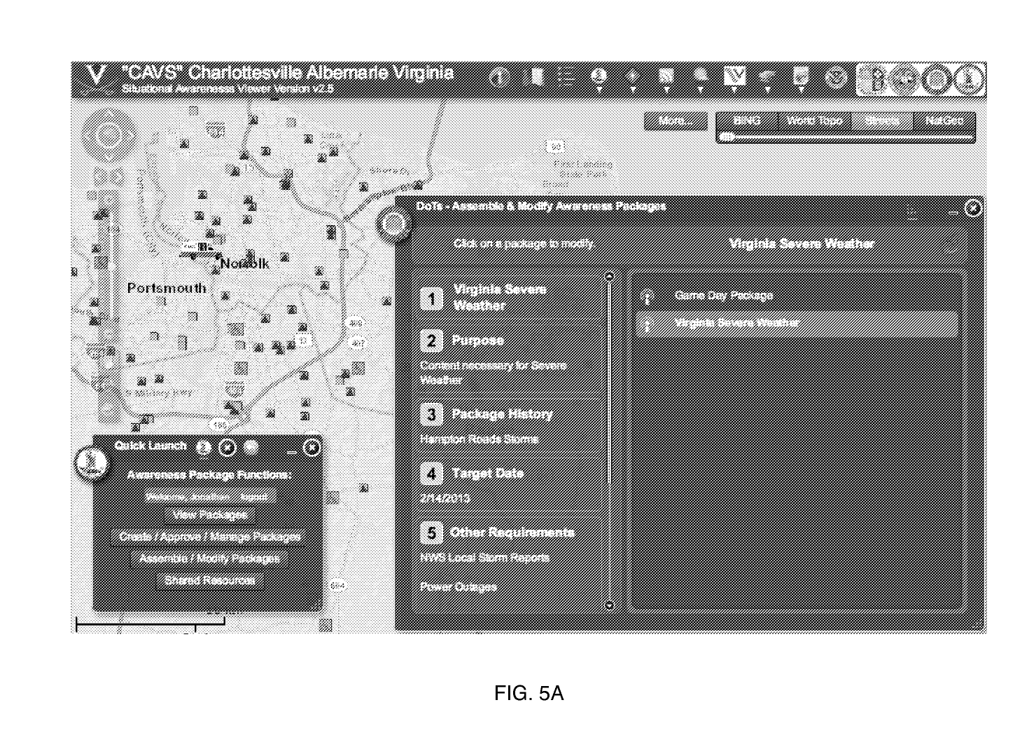

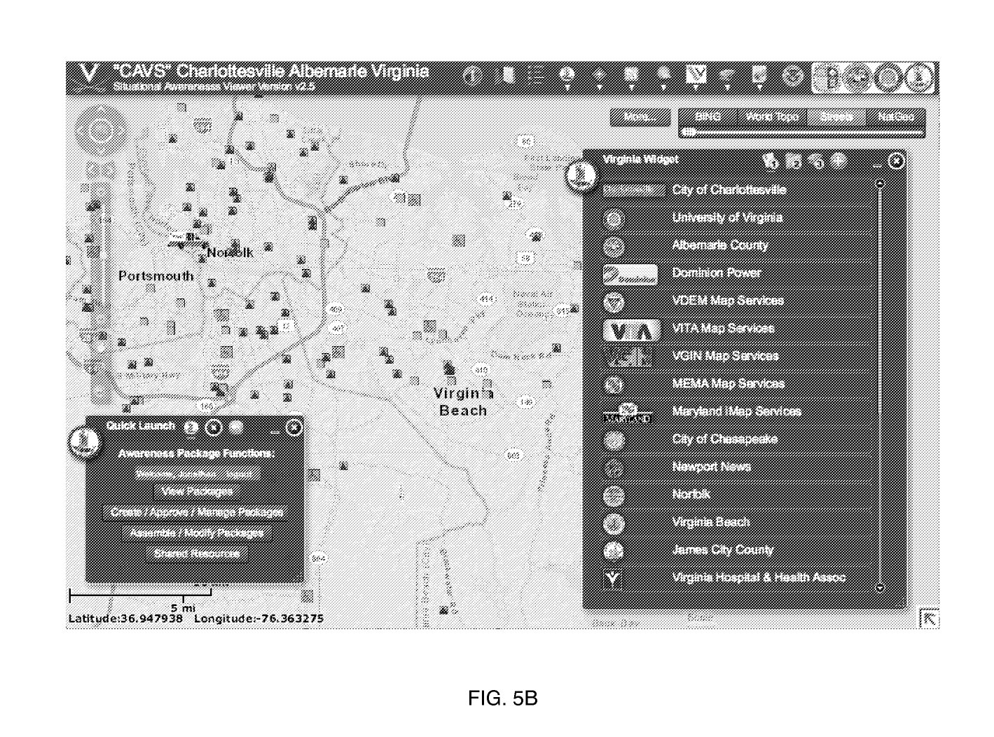

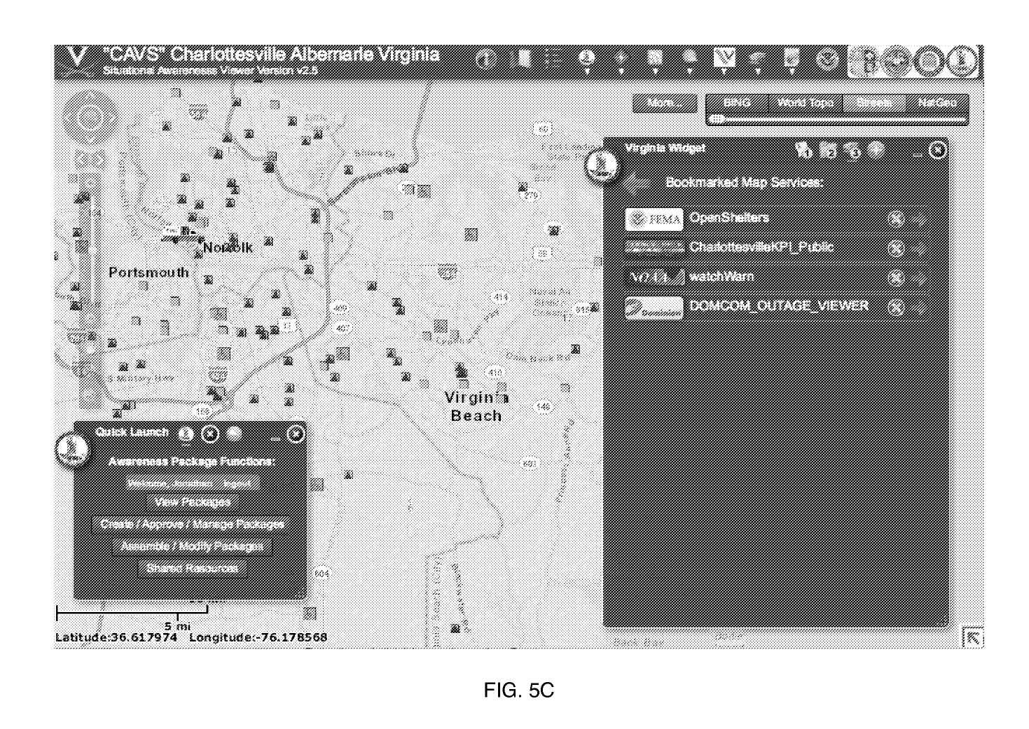

FIG. 5 shows an exemplary workflow for assembling an awareness package. An Analyst starts the workflow at step S500 by selecting an awareness package in the “in-development” state. This awareness package must have been assigned to the Analyst in step S440 above in order for it to be available for selection.

Step S510 branches depending on whether all requested data feeds have URLs assigned. If so, in step S520, the state of the awareness package is changed to “review,” meaning that it is ready for a Commander to review; the workflow then continues with step S550. If not, in step S530 the Analyst picks a data feed that is missing a URL. In step S540, the Analyst uses a catalog to locate an appropriate data feed server. In step S550, the Analyst enters the URL for the data feed server into the awareness package record. The workflow then returns to step S510 or goes to step S550. In step S550, the awareness package is saved to the awareness package server.

FIGS. 5A-5C show exemplary user interfaces for practicing part of the workflow of FIG. 5. FIG. 5A illustrates a user interface for step S500, selecting an awareness package for assembly. FIGS. 5B and 5C illustrate a possible interface for step S540 so that an Analyst can select a data feed from a catalog.

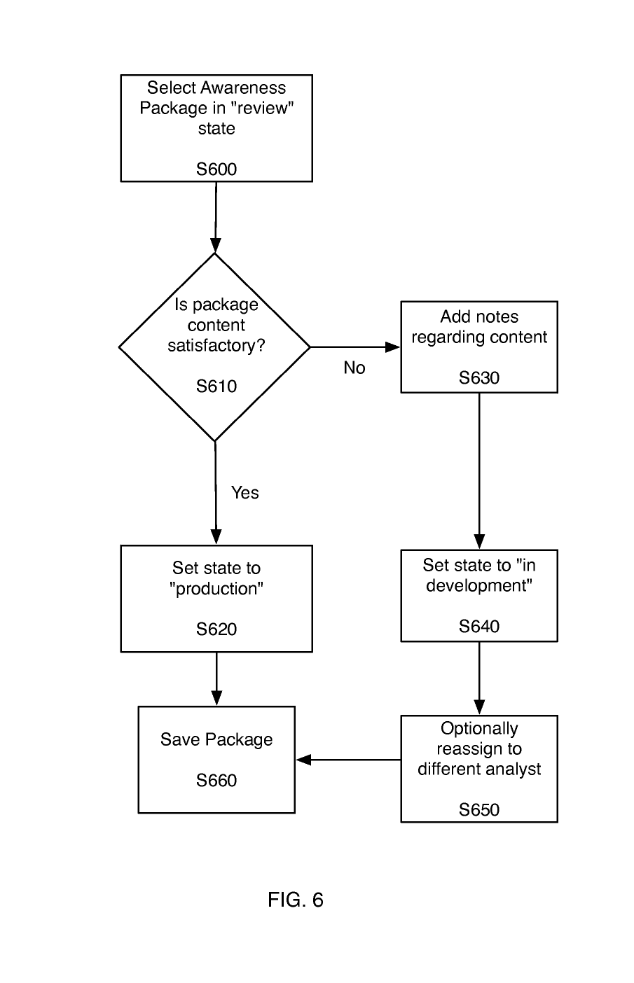

FIG. 6 shows an exemplary workflow for reviewing an awareness package that has been assembled and placed in the “review” state. A Commander (or Administrator) starts the workflow at Step S600 by selecting an awareness package in the “review” state. In step S610, the Commander assesses whether the awareness package is satisfactory. If so, in step S620, the Commander sets the state of the awareness package to “production”; then in step S660, the awareness package is saved.

If the awareness package is not satisfactory, the workflow proceeds to step S630. In that step, the Commander adds notes to explain what needs to be changed in the awareness package. In step S640, the state of the package is changed to “in development,” which will allow an Analyst to edit it. In step S650, the Commander has the option to reassign the awareness package to a different Analyst. Then, in step S660, the awareness package is saved.

Having thus described several illustrative embodiments of the present invention, it is to be appreciated that various alterations, modifications, and improvements will readily occur to those skilled in the art. Such alterations, modifications, and improvements are intended to form a part of the teachings of this disclosure, and are within the spirit and scope of this disclosure of the invention. While some embodiments and examples involve specific combinations of functions or structural elements, it should be understood that those functions and elements may be combined in other ways according to the present disclosure to accomplish the same or different objectives. In particular, acts, elements, and features discussed in connection with one embodiment are not excluded from similar or other appropriate roles in other embodiments.

Additionally, elements and components described herein may be further divided into additional components or joined together to form fewer components that perform the same described functions. For example, the computer server system may comprise one or more physical machines, or virtual machines running on one or more physical machines. In addition, the computer server system may comprise a cluster of computers or numerous distributed computers that are connected by the Internet or another public or private network.

Finally, the description and drawings are examples and embodiments only, and are not intended to limit the scope of the present invention to their literal teachings.

1. A system for presenting emergency management data, comprising:
an awareness package database for storing a plurality of awareness packages, wherein each awareness package comprises:
a state selected from one of a set of states comprising created, in development, in review, and in production;
a description of the purpose of the awareness package; and
a plurality of data feeds, wherein a data feed comprises a description and a uniform resource locator;
an awareness package server for accessing the awareness package database, the awareness package server authenticating at least one user, and wherein access to the awareness package is determined by a role assigned to the at least one user, the role being selected from the set comprising administrator, commander, analyst, standard user, and guest user; and,
an awareness package viewer, wherein the awareness package viewer can be installed on a client machine, the awareness package viewer allowing a user to view data from the plurality of data feeds associated with an awareness package.

2. The system of claim 1, wherein the awareness package viewer is configured to receive map content.

3. The system of claim 2, wherein the awareness package viewer is configured to receive geographical data from a data feed.

4. The system of claim 3, wherein the awareness package viewer is configured to display the geographical data overlaid on the map content.

5. The system of claim 2, further comprising a map content server.

6. The system of claim 1, wherein the awareness package viewer further comprises software applications that provide the creation, assembly, modification, and visualization of awareness packages.

7. The system of claim 1, wherein the awareness package viewer includes a user interface configured to allow a user to create an awareness package.

8. The system of claim 7, wherein the user interface configured to allow a user to create an awareness package is accessible only if the role assigned to the user is administrator or commander.

9. The system of claim 1, wherein each role is associated with a set of permissions.

10. The system of claim 9, wherein the roles have a unique ordering such that each role includes all of the permissions of the roles preceding it in the ordering and for every pair of roles r₁ and r₂ either r₁ precedes r₂ in the ordering or r₂ precedes r₁ in the ordering.

11. The system of claim 1 further comprising an agency database for storing agency information for a plurality of agencies.

12. The system of claim 11 wherein an agency has the ability to share an awareness package with a different agency.

13. The system of claim 12 wherein the ability to share an awareness package is limited to users with the administrator role and awareness packages with the state in production.

14. The system of claim 12 wherein the awareness package is denoted with the logo of the agency that created it.

15. The system of claim 12 wherein the different agency can use the shared awareness package as a template from which to create a new awareness package.

16. The system of claim 1 wherein the plurality of data feeds comprise one or more of links to social media outlets, links to web applications, links to individual and collections of geographic data layers, and links to web accessible pdf documents.

17. The system of claim 1 wherein the awareness package viewer further enables a user to select the plurality of data feeds by choosing data feeds from a list.
